(19) United States
(12) Patent Application Publication
(10) Pub. No.: US 2024/0291002 A1
(43) Pub. Date: Aug. 29, 2024

(54) RECOVERY SYSTEM AND METHOD FOR RECOVERING A RECIRCULATION FLOW EXITING A FUEL CELL

(71) Applicant: HENGST SE, Muenster (DE)

(72) Inventors: Mathias DIEKJAKOBS, Steinfurt (DE); Tobias PIEPER, Lubeck (DE); Martin ROELVER, Havixbeck (DE); Julian NIEHOFF, Coesfeld (DE); Stephan AHLBORN, Senden (DE)

(21) Appl. No.: 18/574,345

(22) PCT Filed: Jun. 21, 2022
(86) PCT No.: PCT/EP2022/066883

§ 371 Date: Dec. 27, 2023

(30) Foreign Application Priority Data
Jul. 1, 2021 (DE) 10 2021 116 946.1

(51) Int. Cl. H01M 8/04119; H01M 8/04082; H01M 8/0662

(52) U.S. Cl. CPC H01M 8/04156; H01M 8/0687; H01M 8/04201

(57) ABSTRACT

The invention relates to a recovery system (10) for recovering a recirculation flow that exits a fuel cell (102) and contains hydrogen, said recovery system comprising an active centrifugal separator (16, 26) designed to separate liquid water from the recirculation flow.

The invention relates to a recovery system for recovering a recirculation flow that exits a fuel cell and contains hydrogen.

The invention further relates to a method for recovering a recirculation flow that exits a fuel cell and contains hydrogen by means of a recovery system.

Fuel cells are usually operated overstoichiometrically. This prevents damage to the membranes of the fuel cell and at the same time ensures the intended reaction in the fuel cell. The excess hydrogen that is not used in the reaction and escapes from the fuel cell is fed back into the fuel cell in a hydrogen recirculation path to avoid wasting the gas. In addition to hydrogen, the recirculation flow exiting the fuel cell usually includes nitrogen as well as gaseous and liquid water.

In the hydrogen recirculation path of fuel cell systems, the hydrogen is often fed through a jet pump operating according to the Venturi principle, which is connected to a hydrogen supply. The hydrogen flow from the hydrogen supply creates a suction effect at the jet pump, which sucks in the recirculation flow and mixes it with the hydrogen from the hydrogen supply. The intake of the recirculation flow depends, inter alia, on the volume flow rate of the flow coming from the hydrogen supply, wherein the nominal variable for regulating the volume flow rate or for maintaining the recirculation of the recirculation flow exiting the fuel cell by the jet pump is usually the fluid pressure.

When there is a high hydrogen demand, i.e. when there is a high load on the fuel cell, the jet pump functions perfectly, as the flow from the hydrogen supply is sufficiently strong and ensures sufficient suction of the recirculation flow. When the hydrogen demand is low, i.e. when the load on the fuel cell is low, the problem is that the jet pump no longer generates sufficient suction due to a flow stall. To counteract the drop in suction effect, it is known to arrange a dosing valve upstream of the jet pump in order to feed the jet pump with hydrogen from the hydrogen supply via the dosing valve in a pulsed, i.e. intermittent, manner. This allows the suction effect to be increased in a limited operating range.

To compensate for the low suction power of the jet pump in the low load range of the fuel cell, an active fan can also be arranged in the recirculation path to support the operation of the jet pump. Up to now, fans with an output of between 300 watts and several kilowatts have been used in this context. However, the production and operation of such fans is comparatively cost-intensive due to their complex design and high energy requirements. Further, the system efficiency is reduced by the comparatively high parasitic power.

Another problem during the operation of fuel cells is the excess hydrogen emerging from the fuel cell absorbs moisture within the fuel cell, entrains water droplets and mixes with nitrogen that has diffused through the membrane in the fuel cell. However, to prevent damage to the fuel cell and to ensure proper operation of the fuel cell, water droplets must not be allowed to get back into the fuel cell, as these can block the distribution channels in the bipolar plates and cover the active reaction surface of the catalyst, which can impair the operation of the fuel cell and damage it. Furthermore, icing of the fuel cell in the idle state due to water residues must be avoided, as this can also lead to damage and functional failure of the fuel cell.

At the same time, a steadily increasing concentration of the nitrogen leads to a dilution effect, which can cause a reduction in the efficiency and thus a loss in performance of the fuel cell. To separate the water from the recirculation path, passive separators such as fabric separators or cyclones have been used up to now, but their separation performance is limited. To discharge the nitrogen, the remaining hydrogen-nitrogen mixture has previously been flushed out of the system cyclically through a flushing valve.

The object on which the invention is based is therefore to improve the recovering of a recirculation flow that exits a fuel cell and contains hydrogen.

The object is achieved by a recovery system of the type mentioned at the beginning, wherein the recovery system according to the invention has an active centrifugal separator which is designed to separate liquid water from the recirculation flow.

By integrating an active centrifugal separator into the hydrogen recirculation path of the fuel cell's anode management system, energy-efficient and effective water separation is implemented so that liquid water, for example in the form of water droplets, is prevented from being introduced into the fuel cell by the recirculation flow. Damage to the fuel cell, for example due to blockage of the distribution channels in the bipolar plates, and functional impairments, for example due to water droplets covering the active reaction surface of the catalyst, are thus effectively avoided.

The recovery system according to the invention is thus a recirculation and separation system which combines the recirculation of hydrogen with the separation of liquid water from the recirculation flow containing hydrogen. The recovery system can further be designed to separate not only the liquid water but also nitrogen from the recirculation flow containing hydrogen.

In a preferred embodiment of the recovery system according to the invention, the active centrifugal separator is formed as a disk separator. In this case, the active centrifugal separator is a disk separator. The active centrifugal separator preferably comprises a rotatably drivable disk pack with a plurality of separator disks arranged one above the other. The disk pack of the active centrifugal separator comprising the separator disks can be designed to allow the recirculation flow containing hydrogen to flow through it from the inside to the outside. Further, the disk pack of the active centrifugal separator comprising the separator disks can be designed to allow the recirculation flow containing hydrogen to flow through it from the outside to the inside.

In a further development, the recovery system according to the invention has a separator drive, which is in particular controllable and/or electromotive. The separator drive is preferably designed to rotationally drive the active centrifugal separator. The recovery system may comprise a control apparatus designed to control the operation of the separator drive, in particular its speed. The control apparatus preferably allows the implementation of a needs-based separation strategy, which is capable of implementing effective water separation in the entire operating range of the fuel cell, i.e. in both low and high load ranges. The control apparatus further allows a targeted power setting on the separator drive.

A recovery system according to the invention which has a conduit system is also advantageous. The recirculation flow can be fed to the active centrifugal separator via the conduit system. Alternatively or additionally, the recirculation flow from the active centrifugal separator can be discharged via the conduit system. Preferably, the active centrifugal separator is designed to support the conveying of the recirculation flow in the conduit system. In addition to the separating function, the active centrifugal separator can also have a conveying function. The conduit system can, for example, comprise a conduit portion which is arranged upstream of the active centrifugal separator in the direction of flow of the recirculation flow and is designed to connect the fuel cell to the active centrifugal separator. The centrifugal separator can develop a suction effect in this conduit portion. The conduit system preferably has one or more conduit portions which are arranged downstream of the centrifugal separator in the direction of flow of the recirculation flow. The active centrifugal separator can be designed to exert a pressure effect in the one or more conduit portions of the conduit system arranged downstream of the centrifugal separator.

In a further preferred embodiment of the recovery system according to the invention, the active centrifugal separator has a rotatably drivable separating apparatus for separating water from the recirculation flow, wherein the separating apparatus is preferably designed to implement, in addition to the separating function, a conveying function for conveying the recirculation flow in a conduit system of the treatment system. The energy required for recirculation to overcome the pressure difference is therefore applied, for example, by a rotating disk pack of the active centrifugal separator formed as a disk separator. For this purpose, the separator disks of the disk pack can have a geometry that supports the conveying effect.

In a further development of the recovery system according to the invention, the separating apparatus has one or more separator disks, wherein one separator disk or several or all separator disks each have one or more conveyor elements supporting the conveying of the recirculation flow. The conveyor elements can be connected to the respective separator disk in a force-fitting, form-fitting and/or material-fitting manner. Alternatively, the conveyor elements can be integral components of the respective separator disks. The one or more conveyor elements can be arranged on the upper side and/or the underside of the separator disks. If a separator disk has several conveyor elements, these are preferably arranged at a distance from one another, for example the conveying elements can be evenly distributed around the circumference of the respective separator disk. The one or more conveyor elements can be, for example, conveyor webs, conveyor blades or conveyor wings.

In another preferred embodiment of the recovery system according to the invention, the active centrifugal separator comprises a conveying apparatus for supporting the recirculation flow. The conveying apparatus can be arranged upstream or downstream of the separating apparatus in the direction of flow of the recirculation flow. The separating apparatus may comprise one or more separating elements. The separating elements can be separator disks of a disk pack. The conveying function can therefore be upstream or downstream of the separator disks, depending on the arrangement of the conveying apparatus. If the conveying apparatus is arranged downstream of the separating apparatus in the direction of flow of the recirculation flow, the required flow rate is reduced, as the volume flow rate to be conveyed is reduced due to the water separation that has already taken place.

The recovery system according to the invention is further advantageously developed in that the conveying apparatus and the separating apparatus are kinematically coupled to one another. For example, the conveying apparatus is driven by a drive shaft of the separating apparatus. Alternatively, the separating apparatus can be driven via a drive shaft of the conveying apparatus. The drive shaft of the conveying apparatus or respectively the drive shaft of the separating apparatus can be driven by the separator drive. The kinematic coupling of conveying apparatus and separating apparatus means that there is no need for separate drives.

In a preferred embodiment of the recovery system according to the invention, the conveying apparatus comprises a pump wheel. Alternatively or additionally, the conveying apparatus comprises a conveying wheel. Further, the conveying apparatus may comprise a screw compressor. Alternatively or additionally, the conveying apparatus can also comprise a side channel blower.

In a further advantageous embodiment, the recovery system according to the invention comprises a bypass conduit which is designed to direct the recirculation flow past the conveying apparatus. The bypass conduit can be blocked and released by a bypass valve. For larger volume flows, the conveying unit can be bypassed by a bypass conduit so that the water-laden recirculation flow can enter the separating apparatus of the active centrifugal separator directly. Hydrogen can then be fed into the water-free recirculation flow from a hydrogen supply, in particular a hydrogen tank, using a feeding apparatus. The advantage of this design is that a low flow rate is required and the overall system can be operated with optimized efficiency. It is further possible to conduct a partial current through the bypass conduit.

In another preferred embodiment of the recovery system according to the invention, the active centrifugal separator is designed to separate gaseous nitrogen from the recirculation flow. The recirculation flow is preferably a hydrogen flow loaded with liquid water and nitrogen. The active centrifugal separator is primarily used to separate liquid water from hydrogen. In addition, the active centrifugal separator can also have a nitrogen separating function. Nitrogen separation takes place mechanically at high speeds, for example. The rotatably drivable separating apparatus can therefore be operated in a nitrogen separation mode at particularly high speeds. With high separation rates for nitrogen, draining of the hydrogen-nitrogen mixture can also be omitted or reduced by longer gas drain intervals, thereby reducing fuel consumption.

Furthermore, a recovery system according to the invention is preferred which has one or more physical or chemical filters or adsorbents which are designed to separate nitrogen from the recirculation flow. The one or more filters or adsorbents are preferably designed to separate the nitrogen using physisorption or chemisorption. The one or more physical or chemical filters or adsorbents are preferably operated in a bypass.

A recovery system according to the invention with a feeding apparatus is further preferred, wherein the feeding apparatus is designed to feed the recirculation flow, after water separation by the active centrifugal separator, to a hydrogen main feed stream for the fuel cell. Via the feeding device, the excess hydrogen discharged from the fuel cell is therefore fed back to the main hydrogen feed stream coming from a hydrogen supply and mixed with it. After feeding the recirculation flow into the main hydrogen feed stream, the hydrogen flow is then fed back into the fuel cell.

A recovery system according to the invention in which the feeding apparatus is formed as a jet pump is also advantageous. The jet pump can also be referred to as an ejector, propellant pump or jet pump. The jet pump can be operated as an ejector or injector. The active centrifugal separator supports the flow conditions at the jet pump required for recirculation of the recirculation flow. This is particularly true in the lower load range of the fuel cell, in which the volume flows are relatively low and the flow conditions at the jet pump are unfavorable for recirculation. The jet pump can be an adjustable jet pump or formed as a variable jet pump.

A recovery system according to the invention which comprises a dosing valve is further advantageous. The feeding apparatus can preferably be fed with hydrogen in a pulsed manner via the dosing valve. With pulsed feeding, the hydrogen is fed to the feeding apparatus intermittently. The dosing valve is preferably arranged between the jet pump and a hydrogen supply. By pulsed feeding of the jet pump with hydrogen, it is possible to increase the suction capacity of the jet pump. This means that recirculation with the jet pump functions even at very low recirculation flows. The housing of the active centrifugal separator can be equipped with a compensation volume for pressure pulsation damping.

In a further preferred embodiment, the recovery system according to the invention has an additional separating apparatus which is designed to separate liquid water from an oxygen supply flow containing oxygen, in particular on a cathode side of the fuel cell. The additional separating apparatus and the separating apparatus can be kinematically coupled to one another. The additional separating apparatus can be passive or active and can be connected upstream or downstream of the separating apparatus. The additional separating apparatus can be part of the active centrifugal separator. The supply air on the cathode side of the fuel cell must be humidified for the fuel cell to operate. Humidification can be carried out by means of a water spray, wherein water droplets form in the supply air and can lead to an overdosage of water in the fuel cell. The fuel cell runs the risk of being flooded. With the additional separating device, droplet separation can be implemented in the air inflow. A membrane humidifier, which takes up a comparatively large installation space, can be dispensed with and a simpler spray mist-based humidification principle with a small installation space requirement can be used. The recovery system thus ensures reliable water separation throughout the entire volume flow rate range of the fuel cell. The additional separating apparatus is preferably a disk separator and/or comprises a disk pack with a plurality of separator disks. For example, the additional separating apparatus is driven via a drive shaft of the separating apparatus. For example, the separating apparatus is driven via a drive shaft of the additional separating apparatus. The drive shaft of the additional separating apparatus or respectively separating apparatus can be driven by the separator drive. The disk packs of the separating apparatus and the additional separating apparatus are preferably separated from one another in a gas-tight manner so that fluid exchange is avoided.

The object on which the invention is based is further achieved by a method of the type mentioned at the beginning, wherein liquid water is separated from the recirculation flow by means of an active centrifugal separator of the recovery system within the scope of the method according to the invention. The method according to the invention is preferably carried out by means of a recovery system according to any of the embodiments described above. With regard to the advantages and modifications of the method according to the invention, reference is thus first made to the advantages and modifications of the recovery system according to the invention.

In a preferred embodiment of the method according to the invention, the active centrifugal separator is rotationally driven by means of a separator drive of the recovery system, which is in particular controllable and/or electromotive. Alternatively or additionally, the operation, in particular the speed, of the separator drive is controlled or regulated by means of a control apparatus of the recovery system. As part of the method, the conveying of the recirculation flow in a conduit system of the treatment system can further be supported by the active centrifugal separator.

In a further preferred embodiment of the method according to the invention, the recirculation flow in a conduit system of the recovery system is supported by a separating apparatus of the active centrifugal separator that implements a conveying function. In this case, the active centrifugal separator has both a separating function and a conveying function. Alternatively, the recirculation in the conduit system of the recovery system is supported by a conveying apparatus of the active centrifugal separator formed separately from a separating apparatus of the active centrifugal separator. In this case, a conveying function is also implemented in the centrifugal separator. However, this is not implemented by the separating apparatus, but by a separate conveying apparatus of the centrifugal separator.

In a further preferred embodiment of the method according to the invention, the recirculation flow is directed past the conveying apparatus by means of a bypass conduit of the active centrifugal separator. Further, separating gaseous nitrogen from the recirculation flow can be carried out by means of the active centrifugal separator. It is also possible for the recirculation flow to be fed to a main hydrogen stream for the fuel cell after hydrogen separation by the active centrifugal separator. The method may further comprise the pulsed feeding of the feeding apparatus with hydrogen via a dosing valve of the recovery system, and/or separating liquid water from an oxygen supply flow containing oxygen, in particular on a cathode side of the fuel cell, by means of an additional separating apparatus of the recovery system.

Preferred embodiments of the invention are explained and described in more detail below with reference to the accompanying drawings, in which:

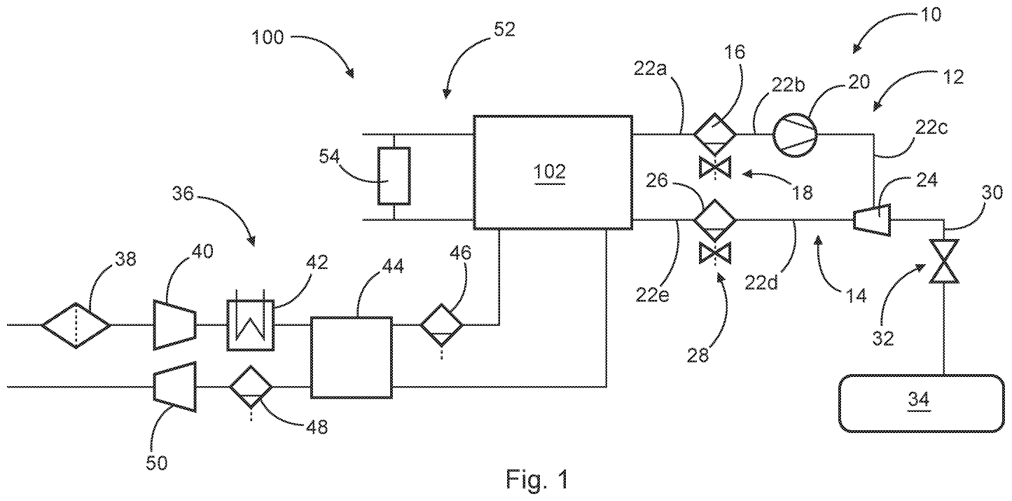

FIG. 1 shows a schematic representation of an exemplary embodiment of the recovery system according to the invention;

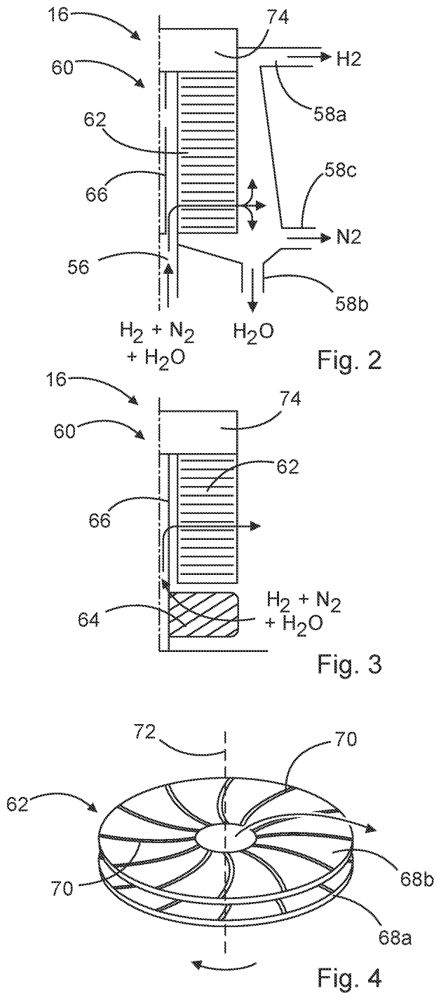

FIG. 2 shows a centrifugal separator of a recovery system according to the invention in a schematic sectional view;

FIG. 3 shows a centrifugal separator of a recovery system according to the invention in a schematic sectional view;

FIG. 4 shows a separator disk of a disk pack of a centrifugal separator in perspective view;

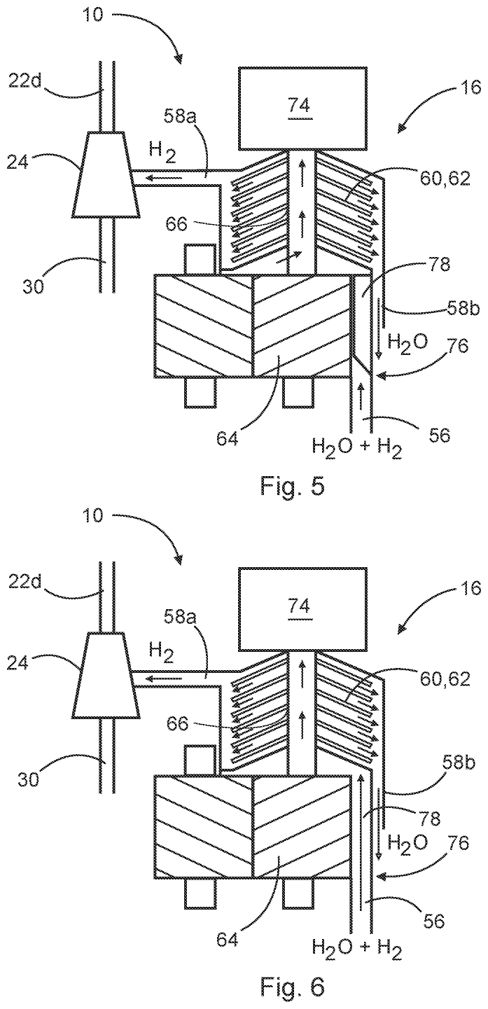

FIG. 5 shows a centrifugal separator of a treatment system according to the invention having a bypass conduit in a schematic representation with the bypass valve closed;

FIG. 6 shows a schematic representation of the centrifugal separator shown in FIG. 5 with the bypass valve open;

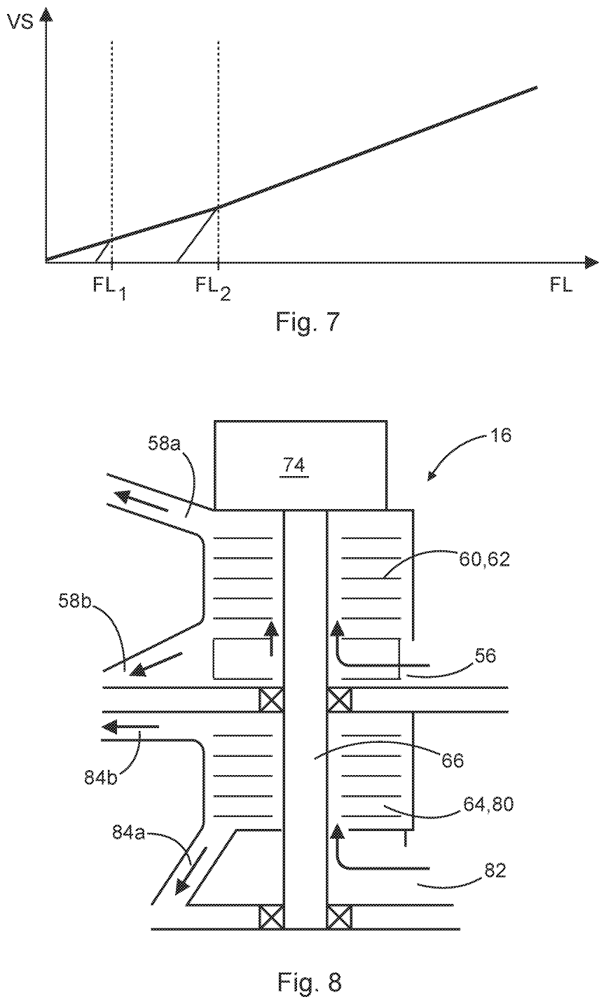

FIG. 7 shows a control scheme for the operation of a recovery system according to the invention; and

FIG. 8 shows another centrifugal separator of a recovery system according to the invention in a schematic representation.

FIG. 1 shows a fuel cell system 100 in which a fuel cell 102 is operated. The fuel cell 102 is connected to a recovery system 10 for recovering fluid flows. On the anode side of the fuel cell 102, a recirculation flow that exits a fuel cell 102 and contains hydrogen is recovered by means of the recovery system 10. The recirculation flow is fed back into the fuel cell 102 via a hydrogen recirculation path 12.

The recovery system 10 comprises a conduit system 14, wherein an active centrifugal separator 16 is integrated into the conduit system 14. The active centrifugal separator 16 is used to separate liquid water from the recirculation flow exiting the fuel cell 102. The active centrifugal separator 16 is formed as a disk separator and comprises a controllable and electromotive separator drive 74. The centrifugal separator 16 is connected to a drain valve 18, via which the water separated from the recirculation flow by the centrifugal separator 16 can be removed from the hydrogen recirculation path 12. The fuel cell 102 is connected to the centrifugal separator 16 via the conduit portion 22a. After the recirculation flow has passed the centrifugal separator 16, the recirculation flow is fed to a conveying apparatus 20 via the conduit portion 22b. The conveying apparatus 20 can be a fan, for example. In the exemplary embodiment shown, the conveying apparatus 20 is formed separately from the centrifugal separator 16. In other exemplary embodiments, the conveying apparatus 20 can also be integrated into the centrifugal separator 16.

The conveying apparatus 20 is connected via a conduit portion 22c of the conduit system 14 to a feeding apparatus 24, which is designed to feed the recirculation flow after water separation by the active centrifugal separator 16 to a hydrogen main feed stream for the fuel cell 102. The feeding apparatus 24 is formed as a jet pump. The active centrifugal separator 16 and the conveying apparatus 20 support the flow conditions required for recirculation at the feeding apparatus 24.

A further centrifugal separator 26 may be arranged between the feeding apparatus 24 and the fuel cell 102. If the feeding apparatus 24 is formed as a jet pump, cooling occurs in the flow direction downstream of the feeding apparatus 24 due to the gas expansion, which can again lead to the formation of condensate. The condensate can be separated from the recirculation flow by means of the centrifugal separator 26. The separated condensate can then be removed from the hydrogen recirculation path 12 via the drain valve 28 connected to the centrifugal separator 26. The feeding apparatus 24 is connected to the centrifugal separator 26 via the conduit portion 22d of the conduit system 14. The centrifugal separator 26 is connected to the fuel cell 102 via the conduit portion 22e of the conduit system 14.

The hydrogen main feed stream flowing through the feeding apparatus 24 has its origin in a hydrogen supply 34, wherein the hydrogen supply 34 may be a hydrogen tank. The hydrogen supply 34 is connected to the feeding apparatus 24 via the dosing valve 32 and the feeding conduit 30. Via the dosing valve 32, the feeding apparatus 24 can be fed with hydrogen from the hydrogen supply 34 in a pulsed manner. By pulsed feeding of the feeding apparatus 24 formed as a jet pump with hydrogen, it is possible to increase the suction capacity of the feeding apparatus 24. As a result, the recirculation of the hydrogen discharged from the fuel cell 102 functions even at low loads, even if the conveying apparatus is not operated or is only operated at low power.

On the cathode side 36, the recovery system 10 is used to recover an oxygen supply flow comprising oxygen. The oxygen supply flow can be an air flow, for example. The oxygen supply flow is first passed through a filter 38, in which solid particles are filtered out of the oxygen supply flow. After passing the compressor 40, the oxygen supply flow is fed to a temperature control apparatus 42, in which the oxygen supply flow can be heated or cooled to a suitable temperature. After temperature control has taken place, the oxygen supply flow is humidified in a humidifier 44. The supply air can be humidified, for example, by means of a water spray generated by the humidifier 44. In this case, water droplets may form, which must be removed from the introduction of the oxygen supply flow into the fuel cell 102. An additional separating apparatus 46 of the recovery system 10 is used for this purpose. The additional separating apparatus 46 can be a passive or an active separating apparatus. For example, the additional separating apparatus is a disk separator driven by an electric motor.

After the hydrogen supply flow has been performed by the fuel cell 102, it is again supplied to the humidifier 44. Before being introduced into an expander 50, liquid water is again separated from the exhaust air flow by means of an additional separating apparatus 48.

The fuel cell 102 is further connected to a coolant circuit 52 via which the fuel cell 102 is cooled during operation. The coolant circuit 52 comprises an ion exchanger 54 which is used to keep the electrical conductivity of the coolant at a low level.

FIG. 2 shows a centrifugal separator 16 formed as a disk separator, in which a recirculation flow containing hydrogen and nitrogen, which is loaded with liquid water, is introduced via an inlet 56. The recirculation flow is passed from the inside to the outside through the disk pack 62 of the separating apparatus 60 of the centrifugal separator 16. The liquid water separated by the rotating disk pack 62 is discharged from the centrifugal separator 16 through outlet 58b. The centrifugal separator 16 is further designed to separate gaseous nitrogen from the recirculation flow. Nitrogen separation takes place, for example, in a nitrogen separation mode with particularly high speeds. The separated nitrogen is discharged from the centrifugal separator 16 via outlet 58c. The recirculation flow, freed of liquid water and nitrogen, is discharged from the centrifugal separator 16 via outlet 58a.

The disk pack 62 is rotationally driven by the separator drive 74. The separator drive 74 is an electric motor which is connected to the disk pack 62 via a drive shaft 66.

In the exemplary embodiment shown in FIG. 3, a conveying apparatus 64 is fastened to the drive shaft 66 in addition to the disk pack 62 of the separating apparatus 60. The conveying apparatus can, for example, be a fan wheel by means of which the recirculation flow is accelerated before being introduced into the disk pack 62. In other embodiments, a speed converter can also be arranged between the disk pack 62 and the conveying apparatus 64, so that the disk pack 62 and the conveying apparatus 64 can be operated at different speeds.

FIG. 4 shows two separator disks 68a, 68b of a disk pack 62 arranged one above the other. Several conveyor elements 70 which support the conveying of the recirculation flow are each arranged on the separator disks 68a, 68b. The conveyor elements 70 are arranged on the upper side and evenly distributed over a circumference of the separator disks 68a, 68b. The conveyor elements 70 are formed as curved conveyor webs and act as conveyor blades. During the rotational movement around the axis of rotation 72, the disk pack 62 also has a conveying function in addition to a separating function.

FIGS. 5 and 6 show a centrifugal separator 16 which has a separating apparatus 60, and a conveying apparatus 64 arranged at a distance from the separating apparatus 60. The active centrifugal separator 16 supports the recirculation flow by means of the conveying apparatus 64, wherein, in the exemplary embodiment shown, the conveying apparatus 64 is arranged upstream of the separating apparatus 60 in the direction of flow of the recirculation flow. In alternative embodiments, the conveying apparatus 64 may also be arranged downstream of the separating apparatus 60 in the direction of flow of the recirculation flow.

The separating apparatus 60 comprises a disk pack 62, wherein the disk pack 62 is rotationally driven by a separator drive 74. The separator drive 74 is a controllable electric motor.

The conveying apparatus 64 and the separating apparatus 60 are kinematically coupled to one another. The conveying apparatus 64 is driven via a drive shaft 66 of the separating apparatus 60, wherein the drive shaft 66 is connected to the separator drive 74. The conveying apparatus 64 can be a pump wheel or a conveyor wheel, for example.

The centrifugal separator 16 further comprises a bypass conduit 78 which is designed to direct the recirculation flow past the conveying apparatus 64. The bypass conduit 78 can be blocked and released by a bypass valve 76. In FIG. 5, the bypass conduit 78 is blocked so that the recirculation flow is directed through the conveying apparatus 64.

In FIG. 6, the bypass conduit 78 is released so that the recirculation flow is partially or completely directed directly to the disk pack 62 of the centrifugal separator 16. This can be particularly advantageous for large volume flows.

FIG. 7 shows a control scheme for the operation of a recovery system 10, wherein the control scheme can be implemented by means of a control apparatus of the recovery system 10. The diagram shows the volume flow rate VS over the flow rate FL within the recirculation path 12. Up to a flow rate FL1, a sufficient volume flow rate can be ensured by operating a conveying apparatus within the recirculation path 12. Above the flow rate FL1 and up to a flow rate FL2, a feeding apparatus 24 formed as a jet pump can then be fed with pulsed hydrogen in the recirculation path. The pulsed feeding can be realized, for example, with a dosing valve 32 between the feeding apparatus 24 formed as a jet pump and the hydrogen supply 34.

FIG. 8 shows a centrifugal separator 16 of a recovery system 10 which has two separation chambers. A separating apparatus 60 comprising a disk pack 62 is arranged in a first separation chamber, which separates liquid water from a recirculation flow flowing in via inlet 56. The separated water is discharged via outlet 58b. The recirculation flow that has been freed of liquid water and contains hydrogen, is discharged from the centrifugal separator 16 via outlet 58a.

A humidified oxygen supply flow is introduced into the second separation chamber via inlet 82. By the rotating disk stack 80, liquid water is separated from the oxygen supply flow within the second separation chamber, wherein the separated water is then discharged from the centrifugal separator 16 via outlet 84a. The oxygen supply flow freed of water is discharged from the centrifugal separator 16 via outlet 84b.

### LIST OF REFERENCE SIGNS

10 recovery system
12 hydrogen recirculation path
14 conduit system
16 centrifugal separator
18 drain valve
20 conveying apparatus
22a-22e conduit portions
24 feeding apparatus
26 centrifugal separator
28 drain valve
30 feeding conduit
32 dosing valve
34 hydrogen supply
36 cathode side
38 filter
40 compressor
42 temperature control apparatus
44 humidifier
46 additional separating apparatus
48 additional separating apparatus
50 expander
52 coolant circuit
54 ion exchanger
56 inlet
58a-58c outlets
60 separating apparatus
62 disk pack
64 conveying apparatus
66 drive shaft
68a, 68b separator disks
70 conveyor elements
72 axis of rotation
74 separator drive
76 bypass valve
78 bypass conduit
80 disk pack
82 inlet
84a, 84b outlets
100 fuel cell system
102 fuel cell
FL flow rate
FL1, FL2 flow rates
VS volume flow rate

1. A recovery system (10) for recovering a recirculation flow that exits a full cell (102) and contains hydrogen,
characterized by an active centrifugal separator (16, 26) designed to separate liquid water from the recirculation flow.

2. The recovery system (10) according to claim 1,
characterized in that the active centrifugal separator (16, 26) is formed as a disk separator.

3. The recovery system (10) according to claim 1 or 2,
characterized by a separator drive (74) which is in particular controllable and/or electromotive which is designed to rotationally drive the active centrifugal separator (16, 26).

4. The recovery system (10) according to any of the preceding claims,
characterized by a conduit system (14) via which the recirculation flow can be fed to the active centrifugal separator (16, 26) and/or via which the recirculation flow can be discharged from the active centrifugal separator (16, 26),
wherein the active centrifugal separator (16, 26) is designed to support the conveyance of the recirculation flow in the conduit system (14).

5. The recovery system (10) according to any of the preceding claims,
characterized in that the active centrifugal separator (16, 26) has a rotatably drivable separating apparatus (60) for separating water from the recirculation flow, wherein the separating apparatus (60) is preferably designed to implement, in addition to the separating function, a conveying function for conveying the recirculation flow in a conduit system (14) of the recovery system (10).

6. The recovery system (10) according to claim 5,
characterized in that the separating apparatus (60) has one or more separator disks (68a, 68b), wherein one separator disk (68a, 68b) or several or all separator disks (68a, 68b) each have one or more conveyor elements (70) supporting the conveying of the recirculation flow.

7. The recovery system (10) according to claim 6,
characterized in that the active centrifugal separator (16, 26) comprises a conveying apparatus (64) for supporting the recirculation flow, wherein the conveying apparatus (64) is preferably arranged upstream or downstream of the separating apparatus (60) in the direction of flow of the recirculation flow.

8. The recovery system (10) according to claim 7,
characterized in that the conveying apparatus (64) and the separating apparatus (60) are kinematically coupled to one another.

9. The recovery system (10) according to claim 7 or 8,
characterized in that the conveying apparatus (64) comprises a pump wheel, a conveying wheel, a screw compressor and/or a side channel blower.

10. The recovery system (10) according to any of claims 7 to 9,
characterized by a bypass conduit (78) which is designed to direct the recirculation flow past the conveying apparatus (64).

11. The recovery system (10) according to any of the preceding claims,
characterized in that the active centrifugal separator (16, 26) is designed to separate gaseous nitrogen from the recirculation flow.

12. The recovery system (10) according to any of the preceding claims,
characterized by one or more physical or chemical filters or adsorbents which are designed to separate nitrogen from the recirculation flow.

13. The recovery system (10) according to any of the preceding claims,
characterized by a feeding apparatus (24) which is designed to feed the recirculation flow, after water separation by the active centrifugal separator (16), to a hydrogen main feed stream for the fuel cell (102).

14. The recovery system (10) according to claim 13,
characterized in that the feeding apparatus (24) is formed as a jet pump.

15. The recovery system (10) according to claim 13 or 14,
characterized by a dosing valve (32) via which the feeding apparatus (24) can be fed with hydrogen in a pulsed manner.

16. The recovery system (10) according to any of the preceding claims,
characterized by an additional separating apparatus (46, 48) which is designed to separate liquid water from an oxygen supply flow containing oxygen, in particular on a cathode side (36) of the fuel cell (102), wherein the additional separating apparatus (46, 48) and the separating apparatus (60) are preferably kinematically coupled to one another.

17. A method for recovering a recirculation flow that exits a fuel cell (102) and contains hydrogen by means of a recovery system (10), in particular by means of a recovery system (10) according to any of the preceding claims,
characterized by the step of:
separating liquid water from the recirculation flow by means of an active centrifugal separator (16, 26) of the recovery system (10).

18. The method according to claim 17,
characterized by one, several or all of the following steps:
rotational driving of the active centrifugal separator (16, 26) by means of a separator drive (74) of the recovery system (10), which is in particular controllable and/or electromotive;
controlling or regulating the operation, in particular the speed, of the separator drive (74) by means of a control apparatus of the recovery system (10);
supporting the conveyance of the recirculation flow in a conduit system (14) of the recovery system (10) by the active centrifugal separator (16, 26).

19. The method according to claim 17 or 18,
characterized in that the recirculation flow in a conduit system (14) of the recovery system (10) is supported by a separating apparatus (60) of the active centrifugal separator (16, 26) which implements a conveying function, or by a conveying apparatus (64) of the active centrifugal separator (16, 26) which is formed separately from a separating apparatus (60) of the active centrifugal separator (16, 26).

20. The method according to any of claims 17 to 19,
characterized by one, several or all of the following steps:
directing the recirculation flow past the conveying apparatus (64) by means of a bypass conduit (78) of the active centrifugal separator (16, 26);
separating gaseous nitrogen from the recirculation flow by means of the active centrifugal separator (16, 26);
feeding the recirculation flow after water separation by the active centrifugal separator (16, 26) to a hydrogen main feed stream for the fuel cell (102);
pulsed feeding of the feeding apparatus (24) with hydrogen via a dosing valve (32) of the recovery system (10);
separating liquid water from an oxygen supply flow containing oxygen, in particular on a cathode side (36) of the fuel cell (102), by means of an additional separating apparatus (46, 48) of the recovery system (10).
